(19) United States
(12) Patent Application Publication
(10) Pub. No.: US 2026/0132849 A1
(43) Pub. Date: May 14, 2026

(54) ACTUATOR FOR A PARKING LOCK SYSTEM OF A VEHICLE GEARBOX

(71) Applicant: VALEO ELECTRIFICATION, Cergy Pontoise (FR)

(72) Inventors: Mickael BESNARD, Cergy Pontoise (FR); Abdou SALEMBERE, Cergy Pontoise (FR); Frederic RIBERA, Cergy Pontoise (FR)

(73) Assignee: VALEO ELECTRIFICATION, Cergy Pontoise (FR)

(21) Appl. No.: 19/118,808

(22) PCT Filed: Nov. 16, 2023
(86) PCT No.: PCT/EP2023/082043

§ 371 Date: Apr. 7, 2025

(30) Foreign Application Priority Data
Nov. 16, 2022 (FR) FR2211931

(51) Int. Cl. F16H 63/34

(52) U.S. Cl. CPC F16H 63/3466

(57) ABSTRACT

An actuator for a parking lock system of a vehicle transmission gearbox. The actuator includes an electric motor having a casing in which a stator and a rotor are housed, the rotor being connected to a rotary shaft, the rotation of said shaft being guided by at least two guide elements. The actuator further includes a mechanism with a wheel and a worm situated on the drive shaft. At least two rings are mounted on the drive shaft so that, under the effect of an axial force generated by the wheel on the worm, at least one of the rings abuts against the casing or against at least one of the guide elements in order to generate friction torque, thus placing the actuator in a wedged condition.

The invention relates to an actuator for a parking lock system of a vehicle gearbox, in particular an automotive vehicle equipped with an automatic gearbox, for example a hybrid vehicle. The invention also applies to a parking lock system of a reducer associated with an electric vehicle motor. The gearbox or the reducer will more generally be referred to as the transmission gearbox. This locking system is better known as a park-lock or parking lock.

Such an actuator allows the transmission gearbox to be locked when parked, by means of an actuation element, for example a lever engaging with teeth of the transmission gearbox.

Actuators of this type are known and are conventionally designed with a worm and wheel gearing system for transmitting the rotational movement of an electric motor to a torque output element of the actuator connected to the actuation element.

It is necessary to provide self-locking of the worm and wheel gearing system when the electric motor is not supplied with electricity in order to prevent unwanted movement of the actuation element when unwanted torque is applied thereto.

The conventional geometry of the teeth of the worm and wheel gearing system does not always make it possible to achieve sufficient self-locking. In order to obtain sufficient self-locking of the worm and wheel gearing system, the angle of attack of the worm must be small, but this design generates a great deal of friction, which results in premature wear of the system and the oversizing of the electric motor. In addition, the self-locking of the worm and wheel gearing system is very sensitive to external parameters such as impacts, vibrations, surface roughness, grease, etc.

One of the aims of the invention is therefore to provide an actuator for a parking lock system of a vehicle transmission gearbox that reliably prevents any unwanted movement of the actuation element when unwanted torque is applied thereto.

The invention thus proposes an actuator for a parking lock system of a vehicle transmission gearbox, said actuator comprising an electric motor having a casing in which a stator and a rotor are housed, said rotor being rotatably connected to a rotary shaft, the rotation of said shaft being guided by at least two guide elements, said actuator further comprising a mechanism with a wheel and a worm situated on the drive shaft, at least two rings being mounted on the drive shaft so that, under the effect of an axial force generated by the wheel on the worm, at least one of the rings abuts against the casing or against at least one of the guide elements in order to generate friction torque thus placing the actuator in a wedged condition.

Conventionally, the casing of the electric motor is coupled to a lid that closes the inner volume of the casing. In the present invention, the term casing should be considered in the broad sense as being the combination of the casing and the lid.

Generally, at least one of the rings abuts against an element that is fixed relative to the stator of the electric motor. The casing and the guide elements are fixed relative to the stator of the electric motor.

The friction of the ring against the casing or against the guide element combined with the friction of the worm and wheel mechanism thus causes the self-locking of the actuator. The actuator being in a wedged condition means that, regardless of the torque applied to the wheel associated with the worm, the electric motor will not rotate. In other words, the mechanical forces associated with the friction of the ring against the casing or against the guide element and the mechanical forces associated with the friction of the worm and wheel mechanism remain in their friction cone.

The primary function of the rings is thus to generate friction torque as explained above, but they also have the secondary function of axially wedging the shaft of the electric motor.

According to the invention, when no axial force is generated by the wheel on the worm, there is axial play between the rings and the casing or the guide elements, and this play is for example between 0.1 and 0.3 mm.

According to the invention, the rings are made from metal, in particular steel. The rings are tight-fitted onto the shaft and/or welded onto the shaft, in particular by laser welding. The shaft is also made from metal, in particular steel.

According to the invention, the guide elements are roller bearings or bearings, in particular sintered bearings. The guide elements are tight-fitted in the casing. More specifically, the guide elements are tight-fitted into the casing and into the lid.

According to an additional feature of the invention, the casing has a front face on the side facing toward the worm and a rear face on the opposite side from the front face, the first element for guiding the rotation of the shaft is situated on the front face of the casing, and the second element for guiding the rotation of the shaft is situated on the rear face of the casing.

According to a first embodiment of the invention, the first ring is situated axially between the first element for guiding the rotation of the shaft and the worm, and the second ring is situated axially between the rotor and the first element for guiding the rotation of the shaft. According to this configuration, one ring is inside the electric motor and the other ring is at least partially outside.

According to a second embodiment of the invention, the first ring is situated axially between the rotor and the second element for guiding the rotation of the shaft, and the second ring is situated at the opposite end of the shaft from the worm. According to this configuration, one ring is inside the electric motor and the other ring is at least partially outside.

According to a third embodiment of the invention, the first ring is situated axially between the rotor and the first element for guiding the rotation of the shaft, and the second ring is situated axially between the rotor and the second element for guiding the rotation of the shaft. According to this configuration, the two rings are inside the electric motor.

According to a fourth embodiment of the invention, the first ring is situated axially between the first element for guiding the rotation of the shaft and the worm, and the second ring is situated axially at the opposite end of the shaft from the worm. According to this configuration, the two rings are at least partially outside the electric motor.

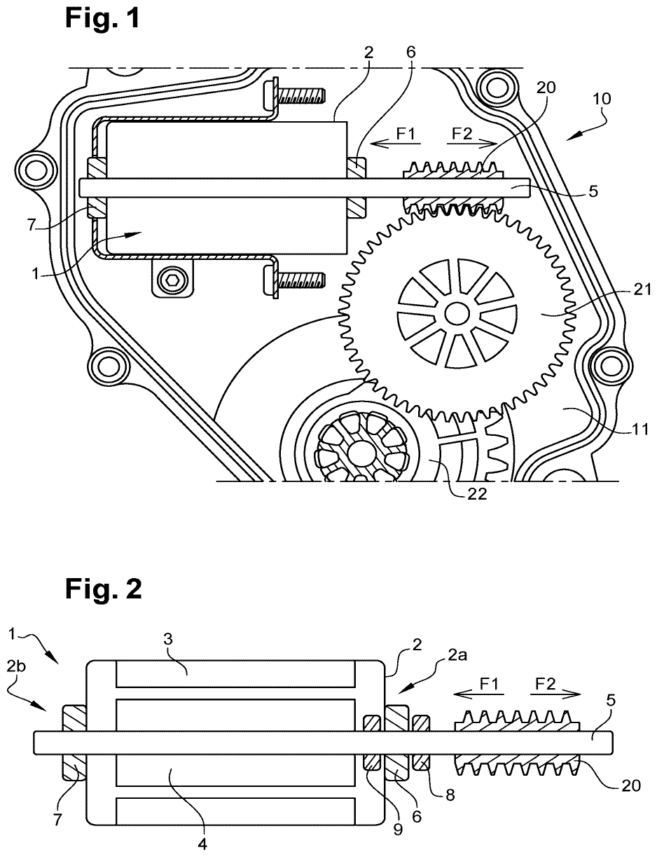

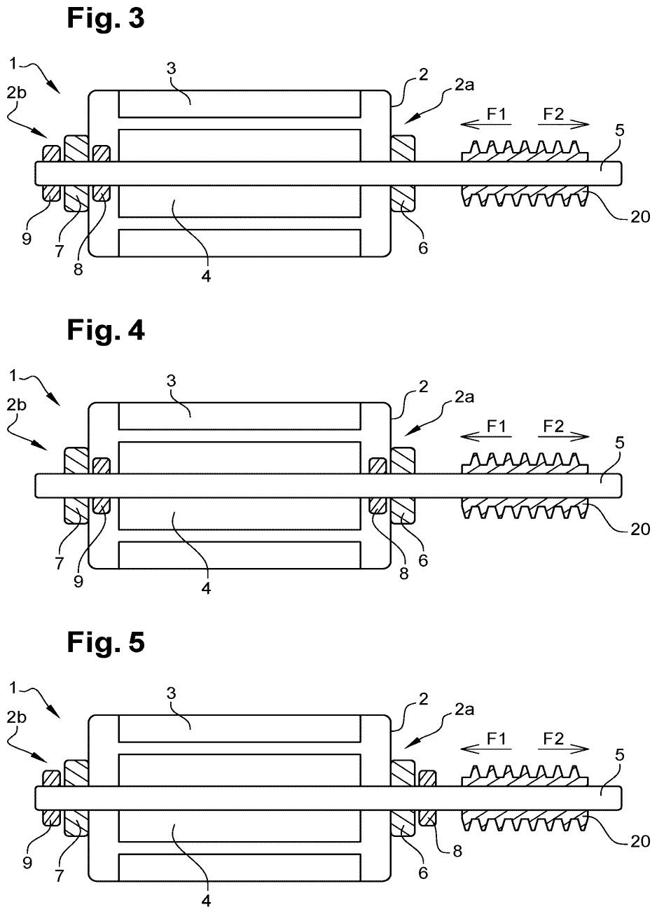

Other features and advantages of the invention will become apparent upon reading the following detailed description of exemplary embodiments, with reference to the appended figures:
FIG. 1 shows an example of an actuator for a parking lock system of a vehicle transmission gearbox to which the invention can be applied;
FIG. 2 shows a first embodiment of the invention;
FIG. 3 shows a second embodiment of the invention;
FIG. 4 shows a third embodiment of the invention;
FIG. 5 shows a fourth embodiment of the invention.

It should be noted that the figures disclose the invention in a sufficiently detailed manner for the implementation thereof, said figures helping to better define the invention as required. However, the invention should not be limited to the embodiments disclosed in the description.

With reference to FIG. 1, an actuator 10 is illustrated for a parking lock system of a vehicle transmission gearbox. The actuator 10 mainly comprises a housing 11, an electric drive motor 1, a geared power transmission system 20, 21, and a torque output element 22 capable of being connected to an actuation element. The housing 11 is capable of being fastened to a vehicle transmission gearbox.

The electric motor 1 is a brushed DC motor with a casing 2 in which a stator 3 and a rotor 4 are housed. The rotor 4 is rotatably connected to a rotary shaft 5 and the rotation of this shaft 5 is guided by two guide elements 6, 7.

The geared power transmission system 20, 21 reduces the speed and increases the torque of the electric motor 1. The geared power transmission system is a worm 20 and wheel 21 system. The worm 20 is on an output shaft 5 of the electric motor 1.

The torque output element 22 is produced in the form of a shaft one end of which takes the form of a star-shaped male or female connector with which the actuation element (not shown) of a locking system is capable of engaging. The locking system makes it possible to lock or unlock teeth of the transmission gearbox (not shown) using an actuation lever or latch (not shown). The torque output element 22 comprises a toothed sector that meshes with the geared power transmission system 21. Under certain conditions, when external torque is applied to the actuation element, this torque is transmitted to the actuator 1 from the torque output element 22, which generates an axial force F1, F2 from the wheel 21 on the worm 20. For optimum use of this actuator, this axial force F1, F2 must cause the self-locking of the actuator.

The invention is illustrated with reference to the following figures, which show four embodiments. These four embodiments have in common two rings 8, 9, also referred to as friction rings, which are mounted on the drive shaft 5 so that, under the effect of an axial force F1, F2 generated by the wheel 21 on the worm 20, at least one of the rings 8, 9 abuts against the casing 2 or against at least one of the guide elements 6, 7 in order to generate friction torque. For example, the friction torque under an axial load of 75 N must be between 10 and 30 Nmm to ensure self-locking.

When no axial force F1, F2 is generated by the wheel 21 on the worm 20, there is axial play between the rings 8, 9 and the casing 2 or the guide elements 6, 7. This play is for example between 0.1 and 0.3 mm.

The rings 8, 9 are made from metal, in particular steel. The rings 8, 9 are tight-fitted onto the shaft 5. More specifically, the rings 8, 9 are welded onto the shaft 5, in particular by laser welding. The shaft 5 is also made from steel.

The casing 2 of the electric motor 1 has a front face 2a on the side facing toward the worm 20 and a rear face 2b on the opposite side from the front face 2a. The first element 6 for guiding the rotation of the shaft 5 is situated on the front face 2a of the casing 2, and the second element 7 for guiding the rotation of the shaft 5 is situated on the rear face 2b of the casing 2. The guide elements 6, 7 are bearings, in particular sintered bearings.

In the first embodiment illustrated in FIG. 2, the first ring 8 is situated axially between the first element 6 for guiding the rotation of the shaft 5 and the worm 20, and the second ring 9 is situated axially between the rotor 4 and the first element 6 for guiding the rotation of the shaft 5.

When a force F1 is generated by the wheel 21 on the worm 20, the first ring 8 abuts against the first guide element 6 or against the front face 2a of the motor 1, that is, the front face of the casing 2.

When a force F2 is generated by the wheel 21 on the worm 20, the second ring 9 abuts against the first guide element 6.

In the second embodiment illustrated in FIG. 3, the first ring 8 is situated axially between the rotor 4 and the second element 7 for guiding the rotation of the shaft 5, and the second ring 9 is situated at the opposite end of the shaft 5 from the worm 20.

When a force F1 is generated by the wheel 21 on the worm 20, the first ring 8 abuts against the second guide element 7.

When a force F2 is generated by the wheel 21 on the worm 20, the second ring 9 abuts against the second guide element 7 or against the rear face 2b of the motor 1, that is, the rear face of the casing 2.

In the third embodiment illustrated in FIG. 4, the first ring 8 is situated axially between the rotor 4 and the first element 6 for guiding the rotation of the shaft 5, and the second ring 9 is situated axially between the rotor 4 and the second element 7 for guiding the rotation of the shaft 5.

When a force F1 is generated by the wheel 21 on the worm 20, the second ring 9 abuts against the second guide element 7.

When a force F2 is generated by the wheel 21 on the worm 20, the first ring 8 abuts against the first guide element 6. In both cases, the abutment combined with the rotation of the shaft 5 generates friction torque and causes the self-locking of the actuator.

In the fourth embodiment illustrated in FIG. 5, the first ring 8 is situated axially between the first element 6 for guiding the rotation of the shaft 5 and the worm 20, and the second ring 9 is situated axially at the opposite end of the shaft 5 from the worm 20.

When a force F1 is generated by the wheel 21 on the worm 20, the first ring 8 abuts against the first guide element 6 or against the front face 2a of the motor 1, that is, the front face of the casing 2.

When a force F2 is generated by the wheel 21 on the worm 20, the second ring 9 abuts against the second guide element 7 or against the rear face 2b of the motor 1, that is, the rear face of the casing 2.

In all of the cases mentioned above, the abutment combined with the rotation of the shaft 5 generates friction torque and causes the self-locking of the actuator.

Although the invention has been described in connection with several particular embodiments, it is quite clear that it is by no means limited thereto and that it includes all the technical equivalents of the means described.

In the claims, the reference signs between parentheses should not be interpreted as limiting the claim.

1. An actuator for a parking lock system of a vehicle transmission gearbox, said actuator comprising an electric motor having a casing in which a stator and a rotor are housed, said rotor being rotatably connected to a rotary shaft, the rotation of said shaft being guided by at least two guide elements, said actuator further comprising a mechanism with a wheel and a worm situated on the drive shaft, wherein at least two rings are mounted on the drive shaft so that, under the effect of an axial force generated by the wheel on the worm, at least one of the rings abuts against the casing or against at least one of the guide elements in order to generate friction torque thus placing the actuator in a wedged condition.

2. The actuator as claimed in claim 1, wherein when no axial force is generated by the wheel on the worm, there is axial play between the rings and the casing or the guide elements, for example of between 0.1 and 0.3 mm.

3. The actuator as claimed in claim 1, wherein the rings are made from metal, in particular steel.

4. The actuator as claimed in claim 1, wherein the rings are tight-fitted onto the shaft and/or welded onto the shaft, in particular by laser welding.

5. The actuator as claimed in claim 1, wherein the guide elements are roller bearings or bearings, in particular sintered bearings.

6. The actuator as claimed in claim 1, wherein the casing has a front face on the side facing toward the worm and a rear face on the opposite side from the front face, the first element for guiding the rotation of the shaft is situated on the front face of the casing, and the second element for guiding the rotation of the shaft is situated on the rear face of the casing.

7. The actuator as claimed in claim 6, wherein the first ring is situated axially between the first element for guiding the rotation of the shaft and the worm, and the second ring is situated axially between the rotor and the first element for guiding the rotation of the shaft.

8. The actuator as claimed in claim 6, wherein the first ring is situated axially between the rotor and the second element for guiding the rotation of the shaft, and the second ring is situated at the opposite end of the shaft from the worm.

9. The actuator as claimed in claim 6, wherein the first ring is situated axially between the rotor and the first element for guiding the rotation of the shaft, and the second ring is situated axially between the rotor and the second element for guiding the rotation of the shaft.

10. The actuator as claimed in claim 6, wherein the first ring is situated axially between the first element for guiding the rotation of the shaft and the worm, and the second ring is situated axially at the opposite end of the shaft from the worm.

11. The actuator as claimed in claim 2, wherein the rings are made from metal, in particular steel.

12. The actuator as claimed in claim 2, wherein the rings are tight-fitted onto the shaft and/or welded onto the shaft, in particular by laser welding.

13. The actuator as claimed in claim 2, wherein the guide elements are roller bearings or bearings, in particular sintered bearings.

14. The actuator as claimed in claim 2, wherein the casing has a front face on the side facing toward the worm and a rear face on the opposite side from the front face, the first element for guiding the rotation of the shaft is situated on the front face of the casing, and the second element for guiding the rotation of the shaft is situated on the rear face of the casing.

15. The actuator as claimed in claim 3, wherein the rings are tight-fitted onto the shaft and/or welded onto the shaft, in particular by laser welding.

16. The actuator as claimed in claim 3, wherein the guide elements are roller bearings or bearings, in particular sintered bearings.

17. The actuator as claimed in claim 3, wherein the casing has a front face on the side facing toward the worm and a rear face on the opposite side from the front face, the first element for guiding the rotation of the shaft is situated on the front face of the casing, and the second element for guiding the rotation of the shaft is situated on the rear face of the casing.

18. The actuator as claimed in claim 4, wherein the guide elements are roller bearings or bearings, in particular sintered bearings.

19. The actuator as claimed in claim 4, wherein the casing has a front face on the side facing toward the worm and a rear face on the opposite side from the front face, the first element for guiding the rotation of the shaft is situated on the front face of the casing, and the second element for guiding the rotation of the shaft is situated on the rear face of the casing.

20. The actuator as claimed in claim 5, wherein the casing has a front face on the side facing toward the worm and a rear face on the opposite side from the front face, the first element for guiding the rotation of the shaft is situated on the front face of the casing, and the second element for guiding the rotation of the shaft is situated on the rear face of the casing.
